(19) United States
(12) Patent Application Publication
(10) Pub. No.: US 2009/0089721 A1
(43) Pub. Date: Apr. 2, 2009

(54) METHOD FOR INCREMENTAL, TIMING-DRIVEN, PHYSICAL-SYNTHESIS OPTIMIZATION

(76) Inventors: Charles J. Alpert, Cedar Park, TX (US); Arvind K. Karandikar, Pune (IN); Zhuo Li, Cedar Park, TX (US); Gijoon Nam, Austin, TX (US); David A. Papa, Austin, TX (US); Chin Ngai Sze, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/866,231

(22) Filed: Oct. 2, 2007

(51) Int. Cl. G06F 17/50

(52) U.S. Cl. 716/2

(57) ABSTRACT

A method, data processing system and computer program product for optimizing the placement of logic gates of a subcircuit in a physical synthesis flow. A Rip Up and Move Boxes with Linear Evaluation (RUMBLE) utility identifies movable gate(s) for timing-driven optimization. The RUMBLE utility isolates an original subcircuit corresponding to the movable gate(s) and builds an unbuffered model of the original subcircuit. Notably, a new optimized placement of the movable gate is yielded to optimize the timing (i.e., maximize the minimum slack) of the original subcircuit, while accounting for future interconnect optimizations. The new subcircuit containing the new optimized gate placement and interconnect optimization is evaluated as to whether a timing degradation exists in the new subcircuit. If a timing degradation exists in the new subcircuit, the RUMBLE utility can restore an original subcircuit and a timing state associated with the original subcircuit.

### BACKGROUND OF THE INVENTION

1. Technical Field

The present invention generally relates to integrated circuit design tools and in particular to integrated circuit design tools that optimize area performance and signal integrity in integrated circuits.

2. Description of the Related Art

Existing methods have sought to improve the placement of negative-slack gates of a circuit in a physical synthesis flow. While several solutions to this problem have existed in the past, there are several drawbacks to these existing solutions. One major drawback of existing solutions is that existing solutions consider only the placement of a single, movable gate within an integrated circuit design. In addition, existing physical synthesis optimization methods consider gates (i.e., clocked repeaters and unclocked repeaters, such as buffers and inverters) unmovable that are adjacent to the single, movable gate, which can possibly over constrain gate placement optimization efforts.

### SUMMARY OF AN EMBODIMENT

Disclosed are a method, system, and computer program product for optimizing the placement of movable gates of a circuit in a physical synthesis flow. A Rip Up and Move Boxes Linear Evaluation (RUMBLE) utility optimizes a timing state of an original subcircuit by determining a new optimized placement(s) of movable gate(s) while accounting for future interconnect optimizations. The RUMBLE utility: (a) identifies and selects movable gate(s) for timing-driven placement optimization; (b) isolates an original subcircuit associated with the movable gate(s); (c) builds an unbuffered RUMBLE model of the original subcircuit; (d) yields a new optimized placement(s) of movable gate(s) using a RUMBLE mathematical program to optimize timing state of the original subcircuit while accounting for the future interconnect optimization (i.e., unclocked repeater insertions, gate re-sizing); (e) creates a RUMBLE tree cache for each non-repeater gate output pin of the original subcircuit; (i) disconnects all tree cache end points from the original subcircuit; (g) creates a new subcircuit by connecting new unoptimized nets to corresponding tree cache end points; (h) evaluates whether a timing degradation exists in the new subcircuit; (i) restores the original subcircuit if a timing degradation exists in the new subcircuit; and (j) retains the new subcircuit if there is no timing degradation in the new subcircuit. According to one embodiment, the RUMBLE utility removes at least one buffer tree before yielding a new optimized placement(s) of the movable gate(s).

The above, as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a high level block diagram representation of a data processing system, according to one embodiment of the invention.

FIG. 2A represents an in-memory representation of an original subcircuit corresponding to an initial stage in the execution of a Rip Up and Move Boxes Linear Evaluation (RUMBLE) utility, according to an illustrative embodiment of the invention.

FIG. 2B represents an in-memory representation of an intermediate subcircuit corresponding to a stage in the execution of the RUMBLE utility whereby the movable gate has been moved to an optimized placement, according to an illustrative embodiment of the invention.

FIG. 2C represents an in-memory representation of the intermediate subcircuit corresponding to a stage in the execution of the RUMBLE utility whereby a set of original unclocked repeaters have been removed from an intermediate subcircuit, according to an illustrative embodiment of the invention.

FIG. 2D represents an in-memory representation of a new subcircuit corresponding to a stage in the execution of the RUMBLE utility whereby interconnect optimizations have been performed on the new subcircuit.

FIGS. 3A-3B represent individual parts of a high level logical flowchart illustrating the improved method of timing-driven gate placement optimization, in accordance with one embodiment of the invention.

### DETAILED DESCRIPTION OF AN ILLUSTRATIVE EMBODIMENT

The illustrative embodiments provide a method, system, and computer program product for optimizing the placement of logic gates of a subcircuit in a physical synthesis flow, in accordance with one embodiment of the invention. Physical synthesis is the process of creating a specification for a physical integrated circuit (IC) given a logic circuit specification. As utilized herein, a logic gate is a computer circuit with several inputs but only one output that can be activated by particular combinations of inputs. Moreover, combinations of logic gates are used to store information in sequential logic systems, forming a latch. In order to improve the overall circuit timing of a subcircuit, one or more movable logic gates are placed on a timing-driven basis by directly maximizing a source-to-sink timing arc.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

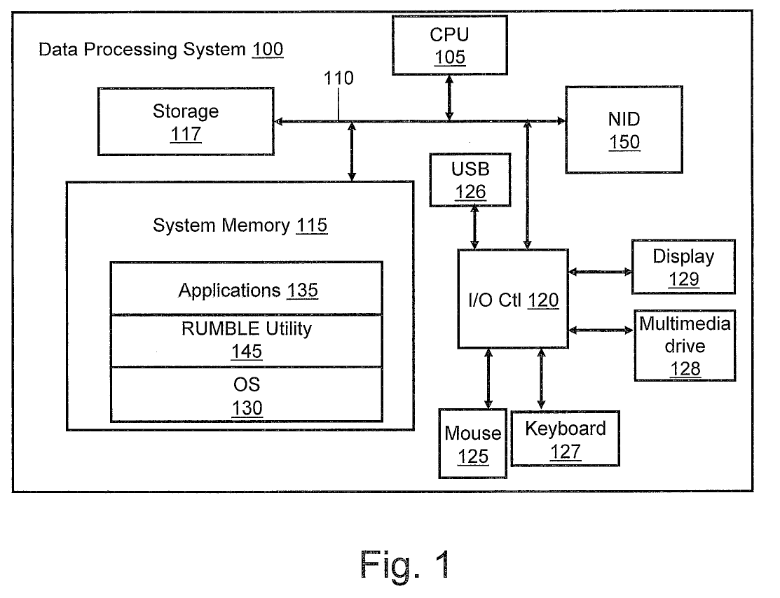

With reference now to FIG. 1, depicted is a block diagram representation of a data processing system (DPS) 100. DPS 100 comprises at least one processor or central processing unit (CPU) 105 connected to system memory 115 via system interconnect/bus 110. Also connected to system bus 110 is I/O controller 120, which provides connectivity and control for input devices, of which pointing device (or mouse) 125 and keyboard 127 are illustrated, and output devices, of which display 129 is illustrated. Additionally, a multimedia drive 128 (e.g., CDRW or DVDRW drive) and Universal Serial Bus (USB) hub 126 are illustrated, coupled to I/O controller 120. Multimedia drive 128 and USB hub 126 may operate as both input and output (storage) mechanisms. DPS 100 also comprises storage 117, within which data/instructions/code may be stored. DPS 100 is also illustrated with a network interface device (NID) 150 coupled to system bus 110. NID 150 enables DPS 100 to connect to one or more access networks, such as the Internet.

Notably, in addition to the above described hardware components of DPS 100, various features of the invention are completed via software (or firmware) code or logic stored within system memory 115 or other storage (e.g., storage 117) and executed by CPU 105. In one embodiment, data/instructions/code from storage 117 populates the system memory 115, which is also coupled to system bus 110. System memory 115 is defined as a lowest level of volatile memory (not shown), including, but not limited to, cache memory, registers, and buffers. Thus, illustrated within system memory 115 are a number of software/firmware components, including operating system (OS) 130 (e.g., Microsoft Windows®, a trademark of Microsoft Corp; or GNU®/Linux®, registered trademarks of the Free Software Foundation and The Linux Mark Institute; or Advanced Interactive eXecutive—AIX—, registered trademark of International Business Machines—IBM), applications (APP) 135, and Rip Up and Move Boxes with Linear Evaluation (RUMBLE) utility 145. In actual implementation, components or code of OS 130 may be combined with those of RUMBLE utility 145, collectively providing the various functional features of the invention when the corresponding code is executed by the CPU 105. For simplicity, RUMBLE utility 145 is illustrated and described as a stand alone or separate software/firmware component, which is stored in system memory 115 to provide/support the specific novel functions described herein.

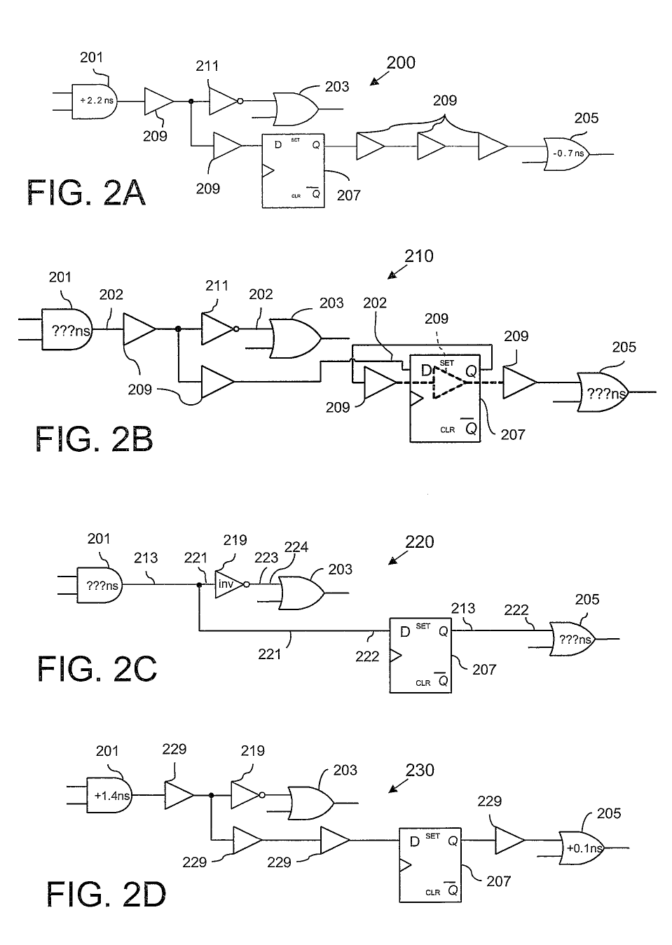

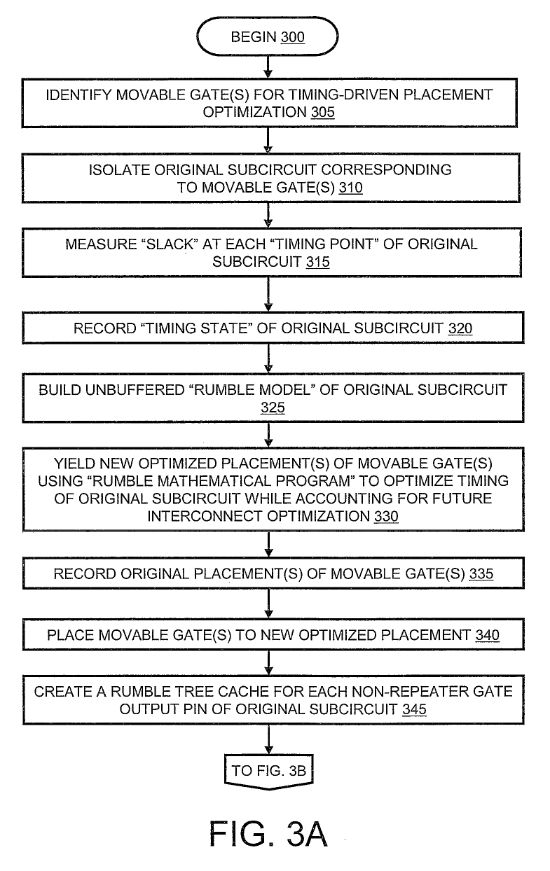

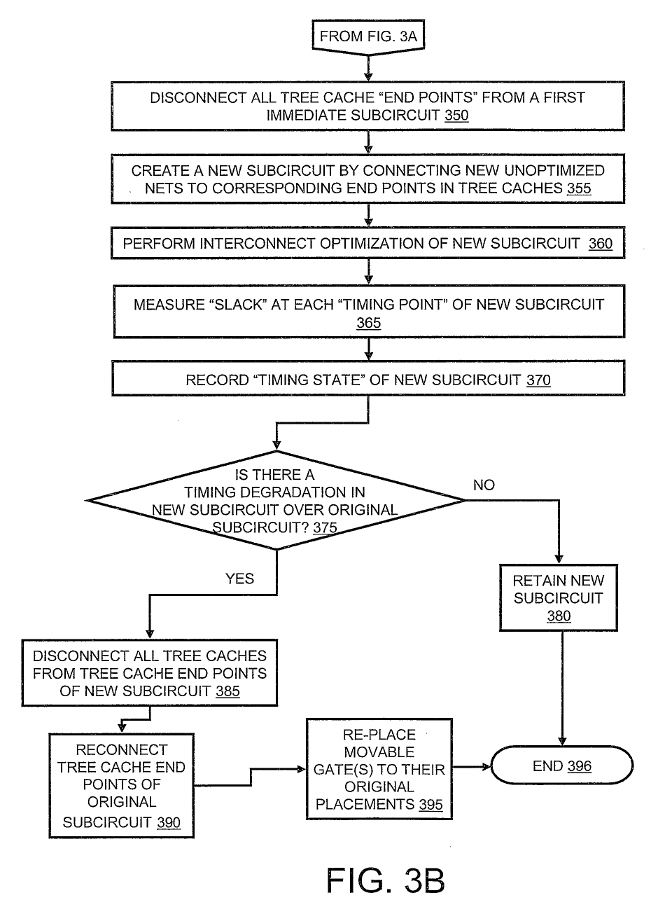

CPU 105 executes RUMBLE utility 145 as well as OS 130, which supports the user interface (UI) features of RUMBLE utility 145. In the illustrative embodiment, RUMBLE utility 145 optimizes a timing state of an original subcircuit by determining a new optimized placement(s) of movable gate(s) while accounting for future interconnect optimizations (i.e., unclocked repeater insertions, gate re-sizing, and the like). Among the software code/instructions provided by RUMBLE utility 145, and which are specific to the invention, are: (a) code for identifying and selecting movable gate(s) for timing-driven placement optimization; (b) code for isolating an original subcircuit corresponding to the movable gate(s); (c) code for building an unbuffered RUMBLE model of the original subcircuit; (d) code for determining new optimized placement(s) of movable gate(s) using RUMBLE mathematical program to optimize timing state of the original subcircuit while accounting for future interconnect optimization; (e) code for creating a tree cache for each non-repeater gate output pin of the original subcircuit; (f) code for disconnecting all tree cache end points from the original subcircuit; (g) code for creating a new subcircuit by connecting new unoptimized nets to corresponding tree cache end points. For simplicity of the description, the collective body of code that enables these various features is referred to herein as RUMBLE utility 145. According to the illustrative embodiment, when CPU 105 executes RUMBLE utility 145, DPS 100 initiates a series of functional processes that enable the above functional features as well as additional features/functionality, which are described below within the description of FIGS. 2A-3B.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Ammonk, N.Y., running the AIX operating system or LINUX operating system.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

With collective reference now to FIGS. 2A-2D, shown are different stages of an exemplary in-memory representation of a subcircuit undergoing physical synthesis optimization. Referring specifically to FIG. 2A, an original subcircuit 200 includes a fixed source gate 201, fixed sink gates 203 and 205, a movable gate/latch 207, and an unclocked repeater tree that includes various buffers 209 and an inverter 211. With reference now to FIG. 2B, an exemplary first intermediate subcircuit 210 is shown at a stage of the physical synthesis optimization whereby the movable gate/latch 207 has been moved to an optimized location on the subcircuit. With reference now to FIG. 2C, an exemplary second intermediate subcircuit 220 is shown at a stage of the physical synthesis optimization whereby the unclocked repeater tree (i.e., buffers 209 and inverter 211) has been removed from the first intermediate subcircuit 210 (FIG. 2B) containing the newly moved gate/latch 207. Referring now to FIG. 2D, a new subcircuit 230 is shown having undergone an interconnect optimization (e.g. new buffer reinsertion forming a new unclocked repeater tree). Future references to FIGS. 2A-2D will be made hereafter in conjunction with a description of FIGS. 3A-3B.

FIGS. 3A-3B represent portions of a flow chart illustrating the exemplary method of optimizing the placement of logic gates of a subcircuit in a physical synthesis flow, according to an illustrative embodiment of the invention. Although the following methods illustrated in FIGS. 3A-3B may be described with reference to components shown in FIGS. 1-2, it should be understood that this exemplary method is merely for convenience and alternative components and/or configurations thereof can be employed when implementing the various methods. Key portions of the methods may be completed by RUMBLE utility 145 (FIG. 1). RUMBLE utility 145 (FIG. 1) executes within DPS 100 (FIG. 1). Moreover, RUMBLE utility 145 (FIG. 1) controls specific operations of/on DPS 100 (FIG. 1). Thus, the methods are described from the perspective of either/both RUMBLE utility 145 (FIG. 1) and DPS 100 (FIG. 1).

The process of FIG. 3A begins at initiator block 300 and proceeds to block 305, at which the RUMBLE utility 145 (FIG. 1) identifies and selects a movable gate(s) 207 (FIG. 2A) for timing-driven placement optimization. In this regard, there are several selection criteria that can be used to identify these movable gate(s). Selection criteria include, but are not limited to, (i) the most critical gate(s) in a circuit, (ii) the most critical paths of a circuit, and (iii) the gate(s) having the largest slack differential between input timing point and output timing point.

As used herein:

a “timing point” is a vertex in a timing graph; conventionally, all gate pins (input or output) in a circuit have an associated timing point;

a “slack” at a timing point is defined as the difference between the required arrival time (RAT) at the timing point and the actual arrival time (AAT) at the timing point. A negative slack value indicates that the signal that is sent to the input of the timing point is actually arriving beyond its required arrival time. A positive slack value indicates that the signal is arriving before its required arrival time.

a “critical gate” is a gate that is characterized as having a negative slack value;

a “critical path” is a sequence of connected gates, which are all characterized as having a negative slack value; and

a “slack differential” is defined as the difference between the smallest slack value of an output timing point and the largest slack value of an input timing point; or vice versa. A large slack differential, especially when either the input timing point or the output timing point has a negative slack value, indicates that the latch timing can likely be improved by moving the movable gate/latch.

Once a movable gate(s) is/are selected for placement optimization, the RUMBLE utility 145 isolates an original subcircuit 200 (FIG. 2A) adjacent to the movable gate(s) 207 (FIG. 2A), as depicted in block 305. The original subcircuit 200 (FIG. 2A) includes the movable gate(s) 207, all clocked repeater source gate(s) 201 (FIG. 2A) and all clocked repeater sink gate(s) 203 and 205 (FIG. 2A) corresponding to the movable gates(s) 207. Note that in order to isolate the original subcircuit 200 from an entire logic circuit (not shown), the RUMBLE utility 145 must identify the boundaries of the original subcircuit 200. This is achieved by identifying the movable gate(s) and then tracing the circuit path from the output and input pins of the movable gate(s) until it reaches the source and sink gate(s) by passing over any intermediate unclocked repeaters 209, 211 (FIG. 2A) that may be present between the movable gate(s) 207 and their respective source gate 201 and sink gate(s) 203, 205. Unclocked repeaters can be defined as gates that contain only logic signal inputs (e.g. buffers (209, FIG. 2A) and/or inverters (211, FIG. 2A)). The original subcircuit 200 is then measured to determine the slack value at each timing point of the original subcircuit 200, as depicted in block 315. For exemplary purposes only, FIG. 2A shows that the measured slack at the output timing point of source gate 201 is +2.2 ns and the measured slack at the input timing point of the sink gate 205 is −0.7 ns. The timing state of the original subcircuit 200 is recorded for future comparison with subsequent gate placement modifications to the original subcircuit, as depicted in block 320.

Referring now to block 325, the original subcircuit's placement data and timing state are passed to a solver, which creates an unbuffered RUMBLE model (not shown) of an original subcircuit 200. The RUMBLE model of the original subcircuit 200 is represented by a hypergraph (not shown) which contains a vertex for each gate (fixed or movable) in the original subcircuit. Note that unclocked repeaters are not included in the hypergraph because the original subcircuit is modeled within the RUMBLE model as if the buffers 209 and the inverters 211 have been removed. The RUMBLE model also contains a 2-pin edge connecting the source of each net to the sink(s) of that net, again modeling the results based upon a hypothetical removal of any intermediate unclocked repeaters. In addition, the RUMBLE model also contains information as to the identification of movable gate(s) 207 and those gates which are not movable (i.e., source gate 201, sink gates 203 and 205), which are collectively referred to in the RUMBLE model as clock boundaries. Finally, the RUMBLE model will contain for each fixed gate (201, 203, and 205), a RAT if the fixed gate(s) 201, 203, 205 is/are an output of the subcircuit and an AAT if the fixed gate(s) 201, 203, 205 is/are an input of the original subcircuit 200.

A RUMBLE mathematical program is derived from the RUMBLE model of the subcircuit, as shown in block 330. A solver optimizes the RUMBLE mathematical program with the creation of the RUMBLE model. Specifically, the RUMBLE mathematical program is a set of expressions describing an optimization problem. Given an assignment of variables, the RUMBLE mathematical program yields new optimized placements of the movable gate(s) 207, and any other simultaneously optimized values, such as gate sizes or wire sizes. Notably, the RUMBLE mathematical program also accounts for future interconnect optimizations. In the current exemplary embodiment, the RUMBLE mathematical program accounts for downstream applications of buffer insertion by assuming a wire delay that is linearly proportional to the wire's length inside the RUMBLE mathematical program. Such an assumption can only be valid if buffer re-insertion is allowed.

Before the movable gate(s) is/are moved to the new optimized placement(s), the RUMBLE utility records the original placement(s) of the movable gate(s), as depicted in block 335. Then, the movable gate(s) is/are moved to the new optimized placement(s) of an in-memory representation of a physical intermediate circuit, as depicted in block 340 and illustrated in the first intermediate subcircuit 210 (FIG. 2B). It should be appreciated by persons of ordinary skill in the art that the particular in-memory representation shown in FIG. 2B is an unrealizable instantiation of the physical circuit, since the optimally-placed movable gate 207 overlaps with another component (i.e., buffer 209). Subsequent interconnect optimization would be required to realize the physical circuit for the new placement of movable gate 207.

However, before any interconnect optimizations can be performed on any particular net, a RUMBLE Tree Cache for each net corresponding to a non-repeater gate output pin of the original subcircuit is created, as depicted in block 345. A RUMBLE Tree Cache is a facility for storing several possible physical implementations of a particular logical net, each of which has different timing properties. Inside the RUMBLE utility, each non-repeater gate output pin, or opin 213 (FIG. 2C), drives one unclocked repeater tree beginning with a net, treenet, which terminates at a set of non-repeater sinks.

With further reference to the creation of the RUMBLE Tree Cache depicted in block 345, each of the unclocked repeater trees are stored by caching the placements of all the unclocked repeaters (i.e., buffers 209 (FIGS. 2A and 2B)) associated with the unclocked repeater tree. In addition, the placements of all clocked source(s) 201 and all clocked sink(s) 203, 205 corresponding to the unclocked repeater tree are cached. In particular, the clocked sinks of the unclocked repeater tree are cached in two different sink pin groups: ppins 222 (FIG. 2C) and npins 224 (FIG. 2C). Ppins 222 refers to those sinks having a positive polarity. Npins 224 refers to those sinks having a negative polarity (i.e., having an odd number of inverters 219 (FIG. 2B) on the source to sink path).

With reference now to FIG. 3B, The RUMBLE utility 145 (FIG. 1) disconnects all RUMBLE Tree Cache end points 202 (FIG. 2B) from the first intermediate subcircuit 210 (FIG. 2B), as depicted in block 350. In this regard, the output pins of source 201 (FIG. 2B), the output/input pins of the movable gate 207 (FIG. 2B) and all the input pins of the sinks 203, 205 (FIG. 2B) are disconnected from the RUMBLE Tree Cache. A second intermediate subcircuit 220 (FIG. 2C) is created by connecting new logically-equivalent, unoptimized nets to corresponding RUMBLE Tree Cache end points as shown at block 355. In order to create logically-equivalent nets, the cached polarity of the sinks is taken into account. If any negative sinks exist, a place-holder inverter, or inv 219 (FIG. 2C), is created and connected to the output pin of the source sink 203 (FIG. 2C) via a first unoptimized net, or n1, 221 (FIG. 2C). Moreover, a second unoptimized net, or n2, 223, is then connected between the output pin of inv 219 (FIG. 2C) and the input pin of the sink 203 (FIG. 2C). The new unoptimized nets are then assigned any copyable properties that are associated with the treenet. These copyable properties include, but are not limited to, provisional layer assignments or other user-defined values.

After the movable gate 207 (FIG. 2C) has been placed in its “presumably optimized” placement (i.e., since the timing state of the new subcircuit 230 (FIG. 2D) has yet to be determined), it is likely that timing has degraded as a result of capacitance violations on a long wire. With reference now to block 360, the RUMBLE utility 145 improves possible timing degradation by performing interconnect optimizations. Interconnect optimization is reflected by the exemplary embodiment shown in FIG. 2D, in which new buffers 229 are inserted. However the invention is not limited in this regard and other interconnect optimizations can be performed, such as movable gate resizing (or gate repowering) and wire plane assignment.

It is important to note that although the RUMBLE mathematical program theoretically solves for optimal movable gate placement locations under the RUMBLE model, the timing state of the new subcircuit 230 may continue to be degraded after interconnect optimization. In this regard, the RUMBLE mathematical program described in this embodiment is an abstraction of the new subcircuit timing that models the interconnect optimizations (e.g. virtual buffering) by setting a wire delay constant that reflects an estimate of what the timing state will be after interconnect optimizations are actually performed. The RUMBLE model could result in an overly optimistic subcircuit model that results in timing degradation of the new subcircuit 230. For example, the new optimized nets may be optimally placed in congested regions or at blockage sites of the new subcircuit 230 where there is no space for unclocked repeater insertions. Thus, the creation of the RUMBLE tree cache in block 345 allows the circuit designer to store the timing state of the original subcircuit 200 before any physical changes are made to the actual circuit model. The circuit designer may perform future interconnect optimizations with the safety of being able to restore the original subcircuit 200 if the future interconnect optimizations result in a timing degradation of the new subcircuit 230.

After the new subcircuit 230 has undergone interconnect optimization, the slack at each timing point of the new subcircuit 230 is measured and the timing state of the new subcircuit 230 is recorded, as depicted respectively in blocks 365 and 370. For exemplary purposes only, FIG. 2D shows that the measured slack at the output timing point of source gate 201 (FIG. 2D) has reduced to +1.4 ns and the measured slack at the input timing point of the sink gate 205 (FIG. 2D) is +0.1 ns. The RUMBLE utility then determines whether a timing degradation exists in the new subcircuit 230 over the original subcircuit 200, as shown in block 375. The RUMBLE utility selects the subcircuit with the best timing characteristics. If no timing degradation is present in the new subcircuit 230, the new subcircuit 230 is retained, as shown in block 380. Referring to the exemplary embodiment in FIG. 2D, the movable gate re-placement produced an improved change in the measure slack at the sink gate 205 from a previous negative value (−0.7 ns) to a new positive value (+0.1 ns), while retaining a positive slack value (+1.4 ns) at the source gate 201. As a result, both source and sink gates in the new subcircuit 230 contain positive slack values.

However, if timing degradation is present in the new subcircuit 230, the RUMBLE Tree Cache structure is recalled to restore (i) the original subcircuit 200 and (ii) the original subcircuit's timing state. According to the described embodiment, this restoration begins by disconnecting all new tree caches at the tree cache end points of the new subcircuit 230, as depicted in block 385. The tree cache end points of the original subcircuit 200 are then reconnected to their former output source pins and input sink pins, as depicted in block 390. The movable gate(s) is/are re-placed to their original placement(s), as depicted in block 395. The process terminates at block 396.

In the flow chart above (FIGS. 3A-3B), one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware, or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, and the like, thereby making an article of manufacture in accordance with the invention. The article of manufacture containing the programming code is used by either executing the code directly from the storage device, by copying the code from the storage device into another storage device such as a hard disk, RAM, and the like, or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVD ROMs, and transmission type media such as digital and analog communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for optimizing the timing-driven placement of one or more movable gates of a circuit in a physical synthesis flow, the method comprising:
identifying and selecting at least one movable gate based on at least one selection criteria;
isolating an original subcircuit corresponding to at least one movable gate;
measuring a first slack value at each timing point of the original subcircuit;
recording a first timing state of the original subcircuit;
building an unbuffered RUMBLE model of the original subcircuit;
yielding at least one new optimized placement of the at least one movable gate utilizing a RUMBLE mathematical program to optimize timing of original subcircuit while accounting for at least one future interconnect optimization;
recording an original placement of the at least one movable gate;
placing the at least one movable gate at its respective new optimized placement;
creating a RUMBLE tree cache corresponding to each non-repeater gate output pin of the original subcircuit;
disconnecting all tree cache end points from the original subcircuit;
creating a new subcircuit by connecting new unoptimized nets to corresponding tree cache end points;
performing interconnect optimization of the new subcircuit;
measuring a second slack value at each timing point of the new subcircuit;
recording a second timing state of the new subcircuit;
determining whether a timing degradation exists in the second timing state of the new subcircuit as compared to the first timing state of the original subcircuit; and
retaining the new subcircuit if the timing degradation does not exist in the second timing state of the new subcircuit.

2. The method of claim 1, wherein if the timing degradation exists in the second timing state of the new subcircuit, the method further comprises:
disconnecting all tree caches from tree cache end points of the new subcircuit;
reconnecting the tree cache end points of original subcircuit; and
re-placing the at least one movable gate to its original placement.

3. The method of claim 1, the method further comprises removing at least one buffer tree;
wherein the removing step occurs before the step of yielding at least one new optimized placement.

4. The method of claim 1, wherein the step of identifying and selecting at least one movable gate further comprises:
identifying one or more critical gates in a circuit;
identifying one or more critical paths of the circuit; and
identifying one or more gates having the largest slack differential between an input timing point and an output timing point.

5. A data processing system comprising:
a processor;
a system memory coupled to the processor; and
a utility executing on the processor and having executable code for:
identifying and selecting at least one movable gate based on at least one selection criteria;
isolating an original subcircuit corresponding to the at least one movable gate;
measuring a first slack value at each timing point of the original subcircuit;
recording a first timing state of the original subcircuit;
building an unbuffered RUMBLE model of the original subcircuit;
yielding at least one new optimized placement of the at least one movable gate utilizing a RUMBLE mathematical program to optimize timing of original subcircuit while accounting for at least one future interconnect optimization;
recording an original placement of the at least one movable gate;
placing the at least one movable gate at its respective new optimized placement;
creating a tree cache corresponding to each non-repeater gate output pin of the original subcircuit;
disconnecting all tree cache end points from the original subcircuit;
creating a new subcircuit by connecting new unoptimized nets to corresponding tree cache end points;
performing interconnect optimization of the new subcircuit;
measuring a second slack value at each timing point of the new subcircuit;
recording a second timing state of the new subcircuit;
determining whether a timing degradation exists in the second timing state of the new subcircuit as compared to the first timing state of the original subcircuit; and
retaining the new subcircuit if the timing degradation does not exist in the second timing state of the new subcircuit.

6. The data processing system of claim 5, wherein if the timing degradation exists in the second timing state of the new subcircuit, the utility further having executable code for:
disconnecting all tree caches from tree cache end points of the new subcircuit;
reconnecting the tree cache end points of original subcircuit; and
re-placing the at least one movable gate to its original placement.

7. The data processing system of claim 5, the utility further having executable code for removing at least one buffer tree before yielding the at least one new optimized placement.

8. The data processing system of claim 5, wherein the selection criteria comprises:
identifying one or more critical gates in a circuit;
identifying one or more critical paths of the circuit; and
identifying one or more gates having the largest slack differential between an input timing point and an output timing point.

9. A computer program product comprising:
a computer storage medium; and
program code on the computer storage medium that when executed provides the functions of:
identifying and selecting at least one movable gate based on at least one selection criteria;
isolating an original subcircuit corresponding to the at least one movable gate;
measuring a first slack value at each timing point of the original subcircuit;
recording a first timing state of the original subcircuit;
building an unbuffered RUMBLE model of the original subcircuit;
yielding at least one new optimized placement of the at least one movable gate utilizing a RUMBLE mathematical program to optimize timing of original subcircuit while accounting for at least one future interconnect optimization;
recording an original placement of the at least one movable gate;
placing the at least one movable gate at its respective new optimized placement;
creating a tree cache corresponding to each non-repeater gate output pin of the original subcircuit;
disconnecting all tree cache end points from the original subcircuit;
creating a new subcircuit by connecting new unoptimized nets to corresponding tree cache end points;
performing interconnect optimization of the new subcircuit;
measuring a second slack value at each timing point of the new subcircuit;
recording a second timing state of the new subcircuit;
determining whether a timing degradation exists in the second timing state of the new subcircuit as compared to the first timing state of the original subcircuit; and
retaining the new subcircuit if the timing degradation does not exist in the second timing state of the new subcircuit.

10. The computer program product of claim 9, wherein if the timing degradation exists in the second timing state of the new subcircuit, the program code further provides the functions of:
disconnecting all tree caches from tree cache end points of the new subcircuit;
reconnecting the tree cache end points of original subcircuit; and
re-placing the at least one movable gate to its original placement.

11. The computer program product of claim 9, wherein the program code further provides the function of removing at least one buffer tree before yielding the at least one new optimized placement.

12. The computer program product of claim 9, wherein the selection criteria comprises at least one of:
one or more critical gates in a circuit;
one or more critical paths of the circuit; and
one or more gates having the largest slack differential between an input timing point and an output timing point.
